(19) United States
(12) Patent Application Publication
(10) Pub. No.: US 2014/0201039 A1
(43) Pub. Date: Jul. 17, 2014

(54) SYSTEM AND METHOD FOR AN AUTOMATED PROCESS FOR VISUALLY IDENTIFYING A PRODUCT'S PRESENCE AND MAKING THE PRODUCT AVAILABLE FOR VIEWING

(71) Applicant: LIVECOM TECHNOLOGIES, LLC, ABILENE, TX (US)

(72) Inventors: DANIEL LUKE HARWELL, ABILENE, TX (US); NATHAN GERALD HARWELL, ABILENE, TX (US)

(21) Appl. No.: 14/213,653

(22) Filed: Mar. 14, 2014

Related U.S. Application Data
(63) Continuation-in-part of application No. 13/647,241, filed on Oct. 8, 2012.

(51) Int. Cl. G06Q 30/06

(52) U.S. Cl. CPC G06Q 30/0643
USPC 705/27.2

(57) ABSTRACT

Provided are a system and method for providing repeatedly updated visual information for an object. In one example, the method includes receiving a plurality of images of an object from a camera configured to capture the images, where the images are still images that are separated in time from one another and where each image is captured based on a defined trigger event that controls when the camera captures that image. Each image of the plurality of images is made available for viewing via a network as a current image as that image is received, where each image updates the current image by replacing a previously received image as the current image. A notification is received that the image is to be removed from viewing. The current image is then marked to indicate that the object is no longer available.

### CROSS-REFERENCE TO RELATED APPLICATIONS

This application is a continuation-in-part of U.S. application Ser. No. 13/647,241, filed Oct. 8, 2012, and entitled SYSTEM AND METHOD FOR PROVIDING REPEATEDLY UPDATED VISUAL INFORMATION FOR AN OBJECT, which claims the benefit of U.S. Provisional Application No. 61/543,894, filed Oct. 6, 2011, entitled INVENTORY MANAGEMENT AND MARKETING SYSTEM, both of which are incorporated herein in their entirety.

### TECHNICAL FIELD

This application is directed to systems and methods for providing real time or near real time image information about objects to devices via a network.

### BACKGROUND

Online product systems may provide for online viewing of products. For example, the ability to view various products by browsing images exists, but such systems do not adequately handle certain types of products. Accordingly, improved systems and methods are needed.

### BRIEF DESCRIPTION OF THE DRAWINGS

For a more complete understanding, reference is now made to the following description taken in conjunction with the accompanying Drawings in which:

FIG. 1A illustrates one embodiment of an environment within which a system may operate to capture image information and provide that information to one or more devices;

FIG. 1B illustrates a more detailed embodiment of a portion of the system of FIG. 1;

FIG. 2 illustrates a flow chart of one embodiment of a method that may be used with the system of FIG. 1A;

FIGS. 3-5 illustrates embodiments of environments with which the system of FIG. 1A may be used;

FIGS. 6A and 6B illustrate more detailed embodiments of a portion of the flow chart of FIG. 2;

FIGS. 7A and 7B illustrate sequence diagrams representing embodiments of information flows that may occur within a portion of the system of FIG. 1A;

FIG. 8 illustrates a sequence diagram representing one embodiment of information flow that may occur when a new store is set up within the system of FIG. 1A;

FIG. 9 illustrates a flow chart of one embodiment of a method that may be used when a product is removed from the system of FIG. 1A;

FIG. 10 illustrates a flow chart of one embodiment of a method that may be used when a product is added to the system of FIG. 1A;

FIG. 11 illustrates another embodiment of a system using a sensor with the system of FIG. 1A;

FIG. 12 illustrates a sequence diagram representing one embodiment of information flow within the system of FIG. 11.

FIG. 13 illustrates a flow chart of one embodiment of a method that may be used to automate product handling within the system of FIG. 1A;

FIGS. 14A-14C illustrates embodiments of an environment with which the system of FIG. 1A may be used;

FIG. 15 illustrates one embodiment of a device that may be used in the system of FIG. 1A.

### DETAILED DESCRIPTION

Referring now to the drawings, wherein like reference numbers are used herein to designate like elements throughout, the various views and embodiments of a system and method for providing repeatedly updated visual information for an object are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

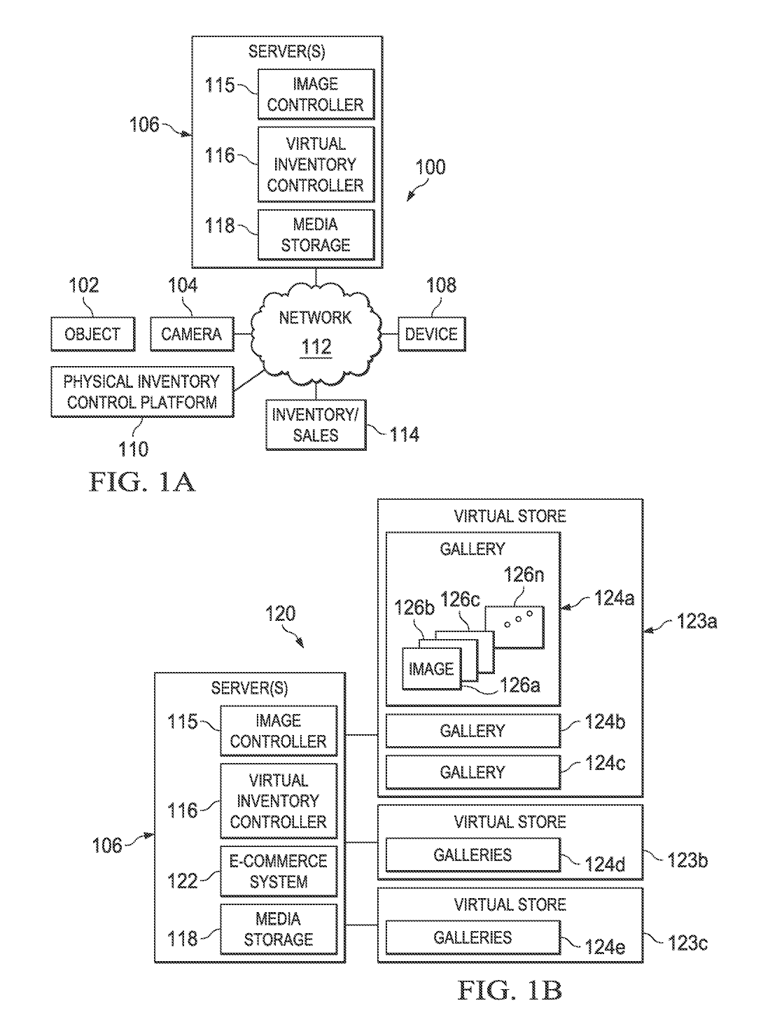

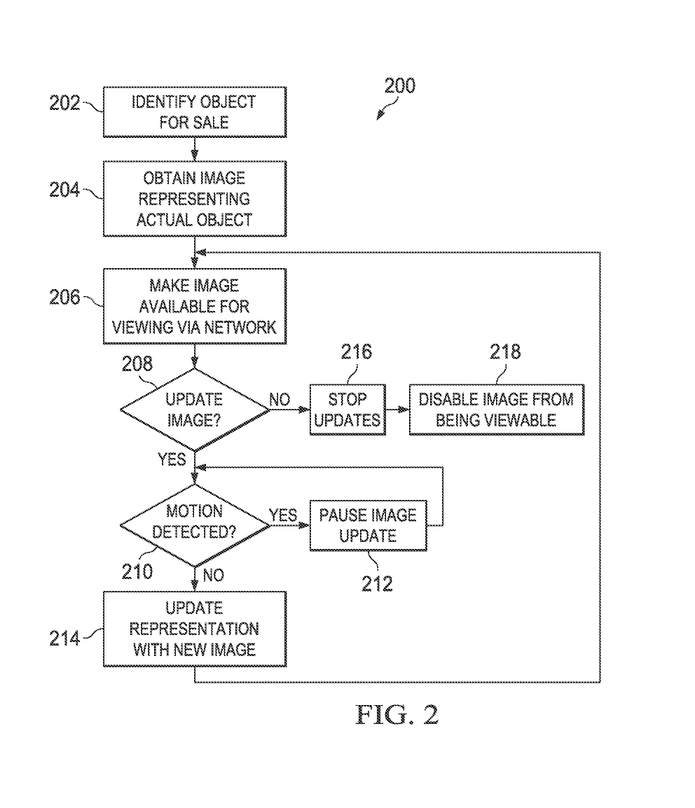

Referring to FIG. 1A, in one embodiment, a system 100 is illustrated within an environment 101. The system 100 may be used to capture images of an object 102 and make those images available for viewing by remotely located viewers. For purposes of illustration, the object 102 is a product that is for sale, but it is understood that the object 102 need not be a product in other embodiments. For example, the object 102 may simply be an object that is to be monitored via a publically available or restricted access interface and the system 100 may be used to provide such monitoring. In the present example where the object 102 is a product for sale, the system 100 provides remote viewers (e.g., potential purchasers) the ability to view the exact object 102 that is for sale.

The ability to view the exact object 102 that is for sale may be particularly desirable if the object is unique. For example, if the object 102 is a flower arrangement, there may be many similar flower arrangements using the same number and types of flowers and the same type of vase, but the object 102 will be unique in that only the object 102 has those particular flowers arranged in that particular way. Accordingly, the health of the flowers, their coloring, how they are arranged in the vase, and similar factors will differ from arrangement to arrangement. Therefore, a generic image may not accurately portray the object 102 due to its unique nature and potential purchasers may be more inclined to purchase the object 102 if they can view the quality of the flowers and how they are arranged. Furthermore, complaints may be minimized as the purchaser was able to view the actual object 102 being purchased, making it more difficult for the purchaser to later claim that the viewed images did not accurately portray the object as may happen when stock photographs are used.

The use of images unique to the particular object 102 may be desirable in many different areas, including the flower arrangements described above. Baked goods, custom art, custom clothing, and any other type of unique items may benefit from the system 100 described herein. Accordingly, the system 100 may be used in many different environments, including flower shops, art galleries, bakeries, pet stores, and may be used in both commercial and non-commercial settings.

In order to provide the images of the object 102, the system 100 may include one or more cameras 104 coupled to one or more servers 106. In other embodiments, the camera 104 may not be part of the system 100, but may be coupled to the system 100. The camera 104 sends images of the object 102 to the server 106, which may in turn provide the images to a device 108 for viewing by a user delivery mechanism such as a web page. In some embodiments, the system 100 may include a physical inventory controller 110. The physical inventory controller 110 may be used to detect the presence of the object 102, which may in turn affect the behavior of the system 100 as will be described in more detail below.

Components of the system 100 may communicate via a network 112 and/or other connections, such as direct connections. For example, the camera 104 may be coupled to a computer (not shown), and the computer may communicate with the server 106 via the network 112. The system 100 may include or be coupled to an inventory/sales system 114 that contains information about the object 102. The information may include information needed for selling the object 102 (e.g., price) and/or internal information (e.g., inventory information such as inventory number and/or availability).

The camera 104 may be any type of device capable of capturing an image of the object 102, and may be embedded in another device or may be a stand-alone unit. For example, the camera 104 may be a webcam coupled to a computer (not shown), an embedded camera (e.g., a camera embedded into a cell phone, including a smart phone), a stand-alone camera such as a traditional camera, and/or any other type of image capture device that is capable of capturing an image of the object 102.

The camera 104 is coupled to the server 106. For purposes of illustration, the camera 102 is coupled to the server 106 via the network 112, but it is understood that other connections (e.g., direct) may be used, such as when the camera 104 and server 106 are in close proximity to one another. It is understood that the connection may vary based on the capabilities of the camera and the actual configuration of the system 100, such as whether the camera 104 is configured for wireless communications (e.g., WiFi, Bluetooth, cellular network, and/or other wireless technologies) or for wired communications (e.g., Universal Serial Bus (USB), Ethernet, Firewire, and/or other wired technologies). For example, the camera 104 may be an Internet Protocol (IP) camera such as a webcam, and may use a wired or wireless connection to a computer or a router. In another example, the camera 104 may be part of a smart phone, and may use a WiFi or cellular wireless connection provided by the smart phone.

The camera 104 captures images in one or more different resolutions, such as high definition. The actual resolution used may vary based on factors such as the camera itself (e.g., the resolutions supported by the camera), bandwidth limitations (e.g., the need to minimize the amount of image data being transferred), the amount of detail needed, and similar issues. The camera 104 may perform image processing (e.g., color/contrast correction and/or cropping) in some embodiments. In other embodiments, the camera 104 may transfer the captured images without performing image processing and processing may be performed by a local computer (not shown) and/or the server 106.

The server 106 may provide image controller 115, virtual inventory controller 116, and/or a storage medium 118 for media (e.g., the captured pictures before and/or after processing occurs). The server 106 may include or be coupled to a database for information storage and management. It is understood that the server 106 may represent a single server, multiple servers, or a cloud environment. In embodiments with both the virtual inventory controller 116 and the physical inventory controller 110, the physical inventory controller 110 may communicate with the virtual inventory controller 116 regarding the status of the object 102.

It is understood that the image controller 115 and virtual inventory controller 116 are described herein in terms of functionality and the implementation of that functionality may be separate or combined. For example, the functionality provided by the image controller 115 and virtual inventory controller 116 may be provided in separate modules (e.g., separate components in an object oriented software environment) that communicate with one another, or may be integrated with the functionality of each combined into a single module. For purposes of illustration, the image controller 115 and virtual inventory controller 116 are described as separate modules.

The physical inventory controller 110 may provide a physical surface on which the object 102 is placed and may be configured to detect the object's presence via a measurement such as weight. In other embodiments, the physical inventory controller 110 may use infrared beams and/or other methods for detecting presence. For example, the physical inventory controller 110 may use an infrared emitter that projects an infrared beam that is reflected from the object 102 and detected by a detector. When the object 102 is not present on the surface of the physical inventory controller 110, the beam is not reflected (or is not reflected with enough intensity) and the surface is considered empty. In some embodiments, a surface of the physical inventory controller 110 may rotate to provide different views of an object for image capture.

The physical inventory controller 110 may include software that communicates with the server 106. The physical inventory controller 110 may detect whether the object 102 is present and stationary and may update the server 106 if the object 102 has been removed or is being moved or adjusted. This enables the server 106 to prevent the online purchase of the object 102 if the object 102 has been removed or is being moved or adjusted. The physical inventory controller 110 may also include one or more input mechanisms (e.g., buttons or a touch screen). The input mechanism may be used to update the server 106 on the state of the object 102. For example, one button may be used to mark the object 102 as sold and another button may be used to mark the object 102 as new. Input received via the input mechanism may be sent by the physical inventory controller 110 to the server 106 to notify the server 106 of a new product and to notify the server 106 that a product is to be removed from inventory.

In some embodiments, only one of the physical inventory controller 110 and the virtual inventory controller 116 may be present. If only the virtual inventory controller 116 is present, the virtual inventory controller 116 may be configured to provide, via software on the server 106 or elsewhere, some or all of the functionality of the physical inventory controller 110. For example, the virtual inventory controller 116 may be used to mark the object 102 as sold or new. In some embodiments, the virtual inventory controller 116 may also provide the ability to crop images, enter and edit prices, enter and edit product descriptions, and perform similar inventory control functions. If the inventory/sales system 114 is present and the system 100 is configured to interact with the inventory/sales system 114, one or both of the physical inventory controller 110 and the virtual inventory controller 116 may communicate with the inventory/sales system 114 in order to synchronize information.

The image controller 115 may be configured to receive and manage images for the object 102. For example, the image controller 115 may receive an image from the camera 104 (or a computer coupled to the camera 104) and stored the image in the media storage 118. The image controller 115 may also perform image processing and/or making the image available for viewing.

Referring to FIG. 1B, an environment 120 illustrates one embodiment of the server 106 of FIG. 1A with functionality for an e-commerce system 122. The server 106 may use the e-commerce system 122 to create and manage one or more virtual stores 123a-123c, each of which may include one or more image galleries. For example, store 123a includes galleries 124a-124c, store 123b includes galleries 124d, and store 123c includes galleries 124e. Each gallery 124a-124e may display one or more images. For example, the gallery 124a may display images 126a, 126b, 126c, . . . , 126N, where N is the total number of images to be displayed. Each image 126a-126N may correspond to a product, although a product may be represented by multiple images in some embodiments (e.g., images from multiple angles). One or more of the images in the galleries 124a-124e may be a gallery image that illustrates multiple objects. For purposes of illustration, the image 126a is a representation of the object 102 of FIG. 1A. The galleries 124a-124e may be viewed by devices 108a and 108b.

In other embodiments, the server 106 may provide images to one or more other servers, which then display the images as desired. Furthermore, it is understood that many different delivery mechanisms may be used for an image, including email, short message service (SMS) messages, social media streams and websites, and any other electronic communication format that can transfer an image. Accordingly, while the e-commerce system 122 may be used in conjunction with the provided images to provide a virtual store with viewing galleries or otherwise provide a display mechanism for the images, it is understood that the images may be sent outside of the system 100 and the present disclosure is not limited to systems that provide the images for viewing to an end user.

The e-commerce system 122 may provide other functions, such as a shopping cart that enables a viewer to select a product, a payment system capable of handling payment (e.g., credit and debit card payments), a search system to enable a viewer to locate one or more products based on key words, and any other functionality needed to provide a viewer with the ability to find and purchase or otherwise select a product.

Some or all of the components operating on the server 106, such as the e-commerce system 122, may be provided by a LAMP (Linux, Apache, MySQL, PHP) based e-commerce system. It is understood that this is only for purposes of example, however, and that many different configurations of the server 106 may be used to provide the functionality described herein. Furthermore, the functionality provided by the e-commerce system 122 may be implemented in many different ways, and may be separate from or combined with the functionality provided by one or both of the image controller 115 and virtual inventory controller 116. For example, the e-commerce system 122 may include or be combined with the image controller 115, virtual inventory controller 116, and/or the media storage 118.

The system 100 may use predefined and publicly available (i.e., non-proprietary) communication standards or protocols (e.g., those defined by the Internet Engineering Task Force (IETF) or the International Telecommunications Union-Telecommunications Standard Sector (ITU-T)). In other embodiments, some or all protocols may be proprietary.

The devices 108a and 108b may be any type of devices capable of receiving and viewing images from the server 106 and/or from another delivery mechanism. Examples of such devices include cellular telephones (including smart phones), personal digital assistants (PDAs), netbooks, tablets, laptops, desktops, workstations, and any other computing device that can communicate using a wireless and/or wired communication link.

It is understood that the sequence diagrams and flow charts described herein illustrate various exemplary functions and operations that may occur within various communication environments. It is understood that these diagrams are not exhaustive and that various steps may be excluded from the diagrams to clarify the aspect being described. For example, it is understood that some actions, such as network authentication processes and notifications, may have been performed prior to the first step of a sequence diagram. Such actions may depend on the particular type and configuration of a particular component, including how network access is obtained (e.g., cellular or Internet access). Other actions may occur between illustrated steps or simultaneously with illustrated steps, including network messaging, communications with other devices, and similar actions.

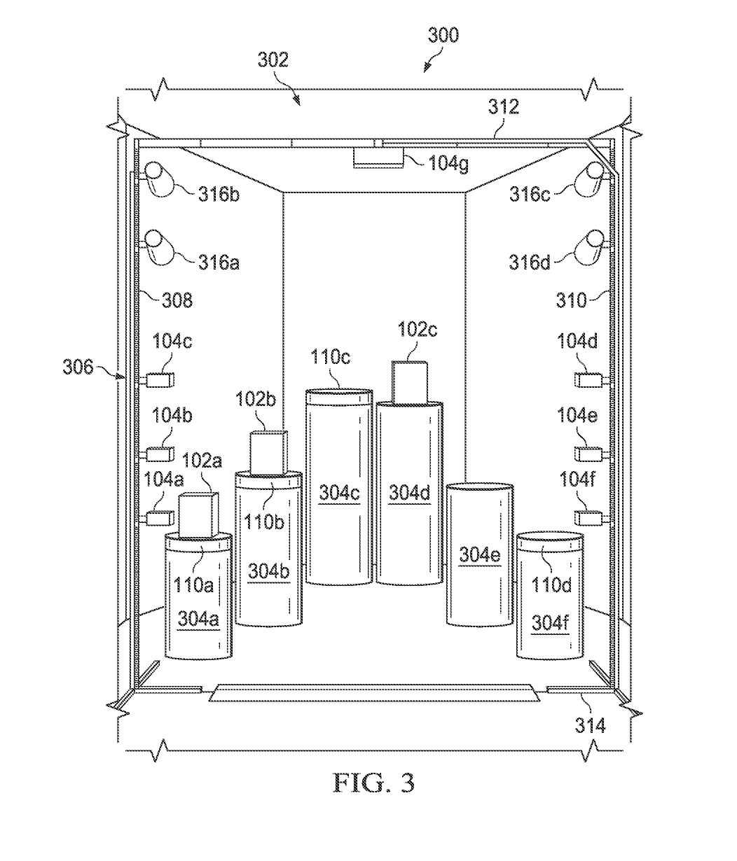

Referring to FIG. 2, one embodiment of a method 200 illustrates a process by which the system 100 of FIG. 1A may operate to provide the image 126a of FIG. 1B. It is understood that the image 126a may be delivered using mechanisms other than the gallery 124a, but the gallery 124a is used herein for purposes of example. In the present example, the method 200 may be executed by the image controller 115 of FIG. 1A.

In step 202, the object 102 is identified by the system 100 as being for sale. This identification may occur due to information received via the physical inventory controller 110, the virtual inventory controller 116 (which may be part of the e-commerce system 122), and/or the inventory/sales system 114. For example, the object 102 may be placed on the physical inventory controller 110 and the button indicating a new product may be pressed or the indication of the new product may occur via the virtual inventory controller 116. The indication may also occur based on other actions, such as scanning a tag or other identifier (e.g., a bar code or radio frequency identification (RFID) tag). The identification of step 202 may be automatic or may require manual action.

In step 204, the image 126a may be obtained via the camera 104. For example, if the camera 104 is a high definition Internet Protocol (IP) camera, the camera 104 may take a high definition picture and send the picture to the server 106 via the network 110 using an IP based protocol such as Transmission Control Protocol (TCP)/IP or User Datagram Protocol (UDP). As described previously, this provides the server 106 with an image of the actual object 102 rather than simply providing a generic representation of the object. In some embodiments, the camera 104 may store the image 126a in a memory accessible to the server 106 (e.g., a cloud storage location) and send the address of the image 126a to the server 106 rather than the image itself. The server 106 may then retrieve the image 126a from the memory. In step 206, the image 126a is made available for viewing via the network 112. Step 206 may include image processing (as will be described later).

In step 208, a determination may be made as to whether the image 126a is to be updated. A new image of the object 102 may be taken based on one or more events, including a continuous time variable trigger (e.g., every time a defined time period elapses, such as every five seconds), a motion activated trigger, a scanner trigger (e.g., information is received from a barcode scanner), and/or a receiver trigger (e.g., information is received from an RFID reader). For example, the image of step 204 may be captured based on a scanner/receiver trigger (e.g., as detected in step 202) or when the object 102 is placed on a physical inventory controller 110. This provides the initial image of the object 102.

The continuous time variable trigger may be used to capture a new image of the object 102 after a defined amount of time has passed (e.g., every so many seconds). This provides a refreshed image so that a viewer can see a more current state of the object 102. For example, if the image 126a is recaptured every ten seconds, the viewer will be able to see what the object 102 looks like within an approximate ten second window and network traffic may be reduced as images are not constantly being updated.

The use of still images that are relatively high in quality (e.g., high definition) enables the object 102 to be represented with a high level of detail, and controlling how quickly the images are updated enables the system 100 to be balanced according to the available bandwidth. For example, in relatively low bandwidth environments (e.g., a smart phone camera using a cell network), either lower resolution images may be captured and sent more frequently or higher resolution images may be captured and sent less frequently. In higher bandwidth environments, high definition images may be sent more frequently. In some embodiments, the images may be updated more frequently to provide substantially constant real time or near real time updates, either with still images or video.

The motion activated trigger may be used to delay image capture if the product is removed, is being moved, and/or if there is movement in front of the camera 104. This is described with respect to steps 210 and 212.

In step 210, if the determination of step 208 indicates that the image is to be updated, a determination may be made as to whether motion has been detected. If movement has been detected, the method 200 may move to step 212 and pause before returning to step 210. It is understood that the determination of step 212 may be made by hardware external to the camera 104, by software within the camera 104, or by software running on an attached computer or the server 106.

For example, a motion detector that is part of the camera 104 or external to the camera 104 may be used to detect motion. When motion is detected, the motion detector may signal the camera 104 or the server 106. In other embodiments, the camera 104 may include software capable of detecting motion, and may not capture an image or may discard a recently captured image if the software determines that movement is occurring. For example, the camera 104 may process the viewable field or a recent image to determine if motion is detected via changes in the field or image that surpass a threshold (e.g., a change between the composition of the viewable field or image at two relatively close times). If the camera 104 is performing the determination of step 212, steps 210 and 212 may be omitted if the camera 104 is not part of the system 100. In such embodiments, the server 106 may simply wait to update the image 126a until a new image is received from the camera. In embodiments where the server 106 or an attached computer handles motion detection, processing may be performed to compare a recently received image with another image to determine whether the pictures indicate motion due to the amount of change that has occurred.

If no motion is detected in step 210, the method 200 continues to step 214, where the representation of the object 102 is updated with a new image 126a. The new image 126a may overwrite the previous image 126a (thereby reducing storage requirements) or the new image 126a may replace previous image 126a while one or more of the previous versions of the image 126a remain stored on the server 106. In other embodiments, step 214 may include sending the image 126a or an address where the image 126a is stored to an external system for display.

The method 200 may then repeat steps 206-214 until a determination is made in step 208 that the image 126a is not to be updated. For example, the object 102 may have been purchased. Once this occurs, the method 200 moves to step 216 and stops updating the image 126a. In step 218, in embodiments that include the e-commerce system 122 or another delivery mechanism and do not send the image 126a to another system for display, the image may be disabled for viewing purposes. The disabling may delete the image or may remove the image 126a from the gallery 124a until the transaction is final, at which time the image 126a may be deleted.

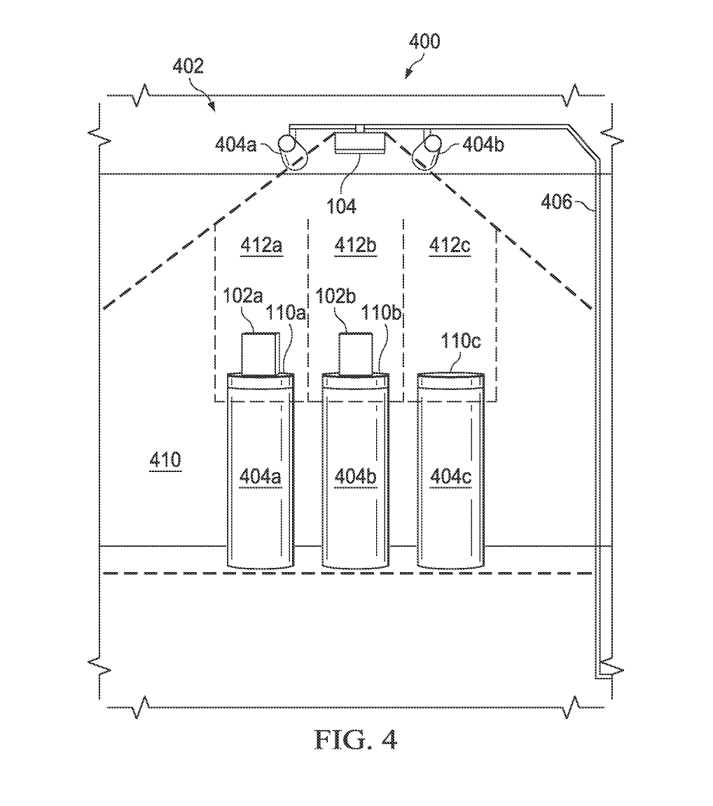

Some steps, such as steps 204 and/or 206, may vary based on the configuration of the system 100. For example, embodiments where a separate camera is used for each object may vary from embodiments where a single camera is used for multiple objects. This is described in greater detail below with respect to FIGS. 3-5.

In some embodiments, multiple images may be taken of a single object to provide additional viewing angles. For example, the object 102 of FIG. 1A may be on a rotating platform that may be a physical inventory controller 110 or may be any other platform configured to rotate at a constant or variable rate. The rate of rotation may be controlled, such as one rotation every eighty seconds. As the platform rotates, the camera 104 may capture multiple images that are synchronized with the rotation of the platform, such as an image every ten seconds during the eighty second rotation period. This would provide eight pictures of the object 102 from eight different angles (e.g., with each picture offset by forty-five degrees from the preceding and following pictures given a constant rotation speed). The system 100 may then enable a viewer to move back and forth through the pictures, giving the impression that the viewer can virtually rotate the object through a three hundred and sixty degree view. As the next rotation period begins, each image for a particular part of the rotation may be replaced as that angle is refreshed with a newly captured image.

It is understood that more or fewer images may be used to increase or decrease the smoothness of the image transitions. For example, capturing one image every twenty seconds would provide four images shifted by ninety degrees, while capturing one image every five seconds would provide sixteen images shifted by twenty-two and a half degrees.

In some embodiments, the rotation may not be synchronized with image capture and images may not be captured at the same point of rotation each time. In such embodiments, existing images may be replaced by new images on a first-in, first-out basis or using another replacement process. For example, if there are eight images used to illustrate the object 102, the ninth captured image may replace the first image regardless of where in the rotation period the first and ninth images were captured.

Referring to FIGS. 3-5, three different configurations of a product display environment are illustrated as an environment 300 in FIG. 3, an environment 400 in FIG. 4, and an environment 500 in FIG. 5. The environment 300 illustrates an embodiment where a separate camera is used to capture images for each object. The environments 400 and 500 illustrate embodiments were a single camera is used to capture images for multiple objects. The environment 400 illustrates the use of a camera to capture a single large image that is then cropped for each object. The environment 500 illustrates the use of a camera that captures a separate image for an object before capturing an image of another object. It is understood that each environment 300, 400, and/or 500 may include objects that are not to be imaged.

Referring specifically to FIG. 3, the environment 300 includes a cooler 302 (e.g., a refrigeration unit for flowers). In the present example, the cooler 302 contains six stands 304a-304f. Each stand 304a-304f may be used to display one or more objects. For purposes of illustration, an object 102a is on stand 304a, an object 102b is on stand 304b, and an object 102c is on stand 304d. Stands 304c, 304e, and 304f are empty.

Each stand 304a-304f may be associated with one or more physical inventory controllers. In the present example, stand 304a is associated with physical inventory controller 110a, stand 304b is associated with physical inventory controller 110b, stand 304c is associated with physical inventory controller 110c, and stand 304f is associated with physical inventory controller 110d. Stands 304d and 304e are not associated with a physical inventory controller. It is understood that in some embodiments, all stands may be associated with a physical inventory controller, while no physical inventory controllers may be present in other embodiments.

A frame 306 is positioned around the cooler 302 with a left vertical support 308 and a right vertical support 310. The frame 306 may also include a top horizontal support 312 and a bottom horizontal support 314. Lights 316a-316d (e.g., egg spotlights) and/or cameras 104a-104g may be coupled to the frame 306. In the present example, a single camera 104a-104f may be directed to each of the stands 304a-304f, respectively. The lights 316a-316d and/or cameras 104a-104f may be adjustable along the left and right vertical supports 308 and 310 to allow optimal positioning for image capture while allowing for easy movement within the cooler 302. In some embodiments, the camera 104g may be coupled to the top horizontal support 312 (as shown) or to the ceiling of the cooler 302 to provide an overview image of the contents of the cooler 302.

It is understood that the frame 306 is used for purposes of illustration and that many different types of frames and frame configurations may be used. For example, in some embodiments, the frame 306 may be replaced by one or more free-standing supports, such as a tripod and/or a monopod. In other embodiments, various components (e.g., cameras and/or lights) may be coupled to the walls, suspended from the ceiling, and/or otherwise positioned so as to provide needed lighting and/or image capture functionality without the need for the frame 306.

In operation, each camera 104a-104f may capture an image of an object placed on the corresponding stand 304a-304f. In the present example, only cameras 104a, 104b, and 104d may capture images, as only stands 304a, 304b, and 304d are holding objects. Accordingly, cameras 104c, 104e, and 104f may be off or otherwise configured to not capture images. In other embodiments, all cameras 104a-104f may capture images, but the images from cameras 104c, 104e, and 104f may be discarded before or after reaching the server 106. In still other embodiments, the images captured by the cameras 104c, 104e, and 104f may be available for viewing even though there is no object placed on the corresponding stands. After capture, the images are passed to the server 106 as described with respect to FIG. 2.

Although not shown, objects may exist in the environment 300 that are not intended to be captured as images. For example, only particular flower arrangements may be intended to be displayed online even though other arrangements are also present in the cooler 302. Accordingly, cameras may be turned off, captured images may be discarded, and/or some objects may not be associated with a camera at all. Therefore, the environment 300 may be configured in many different ways to provide image captures of particular objects.

Referring specifically to FIG. 4, the environment 400 includes a cooler 402. In the present example, the cooler 402 contains three stands 404a-404c. Each stand 404a-404c may be used to display one or more objects. For purposes of illustration, an object 102a is on stand 404a and an object 102b is on stand 404b. Stand 404c is empty. Each stand 404a-404c may be associated with one or more physical inventory controllers. In the present example, stand 404a is associated with physical inventory controller 110a, stand 404b is associated with physical inventory controller 110b, and stand 404c is associated with physical inventory controller 110c. It is understood that in some embodiments, all stands may be associated with a physical inventory controller, while no physical inventory controllers may be present in other embodiments.

A rail 406 is positioned in the cooler 402. Lights 408a and 408b and/or a camera 104 may be coupled to the rail 406. The lights 408a and 408b and/or camera 104 may be adjustable along the rail 406. It is understood that the rail 406 is used for purposes of illustration and that many different types of rails and rail configurations may be used.

In the present example, the camera 104 has an image capture area 410 that is larger than either object 102a and 102b. Accordingly, the image captured by the camera 104 may be divided into smaller sections that are sized to accommodate a particular object. For example, the image may be divided into a first area 412a sized to capture an object on stand 404a (e.g., the object 102a), a second area 412b sized to capture an object on stand 404b (e.g., the object 102b), and a third area 412c sized to capture an object on stand 404c. It is understood that the areas 412a-412c may have different sizes and/or shapes.

In operation, the camera 104 captures an image of all objects placed on the corresponding stands 404a-404c. The captured image is then divided into one or more of the areas 412a-412c. For example, the image may be cropped into three separate images, with each image illustrating one of the areas 412a-412c. In other embodiments, clickable areas may be selected to define the areas 412a-412c, and clicking on one of those areas may provide a close up of that area, either as a zoomed view on the gallery image or as a separate image. The division of the image may be performed before or after sending the image to the server 106. By defining the areas to be shown, other areas of the image capture area 410 may be excluded.

Although not shown, objects may exist in the environment 400 that are not intended to be captured as images. For example, only particular flower arrangements may be intended to be displayed online even though other arrangements are also present in the cooler 402. Accordingly, areas within the image capture area 410 may be defined to exclude such objects. Therefore, the environment 400 may be configured in many different ways to provide image captures of particular objects.

Referring specifically to FIG. 5, the environment 500 includes a cooler 502. In the present example, the cooler 502 contains eight stands 504a-504h and two shelves 506a and 506b. Each of the stands 504a-504h and shelves 506a and 506b may be used to display one or more objects. For purposes of illustration, an object 102a is on stand 504a, an object 102b is on stand 504b, an object 102c is on stand 504e, an object 102d is on shelf 506a, and an object 102e is on shelf 506b. Stands 504c, 504d, and 504f-h are empty.

Each of the stands 504a-504h and shelves 506a and 506b may be associated with one or more physical inventory controllers. In the present example, stands 504a-504g are associated with physical inventory controllers 110a-110g, respectively, and shelf 506a is associated with physical inventory controllers 110h and 110i. Stand 504h and shelf 506b are not associated with any physical inventory controllers. It is understood that in some embodiments, all stands and shelves may be associated with a physical inventory controller, while no physical inventory controllers may be present in other embodiments.

A support member 508 (e.g., a monopod or tripod) is positioned in or outside of the cooler 502. A camera 104 is positioned on the support member 508. In the present example, the camera 104 is controllable and may be moved to capture various objects. For example, the camera 104 may be programmable or may be controlled via a computer to capture various images in a particular sequence. The control may extend to functionality such as zooming to provide improved images for later viewing.

In operation, the camera 104 captures an image of all objects according to the configuration established for the camera 104. For example, the camera 104 may be controlled to rotate through the various stands and shelves to capture single images represented by areas 510a-510l. The camera 104 may also be controllable to skip certain areas in which no objects are present. For example, the physical inventory controller 110a may indicate to the camera 104 and/or server 106 that the object 102a is present and the camera 104 may then capture an image of the object 102a. Accordingly, in the example of FIG. 5, the camera 104 may only capture areas 510a, 510b, 510e, 510j, and 510l. In other embodiments, the camera 104 may capture all areas and images of empty areas may be discarded. In still other embodiments, the camera 104 may capture all areas and images of empty areas may be viewable with no object shown. The images are then passed to the server 106 as described with respect to FIG. 2.

Although not shown, objects may exist in the environment 500 that are not intended to be captured as images. For example, only particular flower arrangements may be intended to be displayed online even though other arrangements are also present in the cooler 502. Accordingly, cameras may be turned off, captured images may be discarded, and/or some objects may not be associated with a camera at all. Therefore, the environment 500 may be configured in many different ways to provide image captures of particular objects.

It is understood that the environments 300, 400, and 500 may be configured in many different ways. For example, a single camera may be used for multiple galleries. The number of cameras and lights, mounting positions, the locations of stands, shelves, lights, and/or cameras may be varied. In embodiments where objects are not static (e.g., a pet store), a configuration may be adopted that will provide needed image capture while allowing movement within the environment.

It is further understood that the environments 300, 400, and 500 may be combined in different ways. For example, the controllable camera 104 of FIG. 5 may be used to capture a gallery view of all or a portion of a cooler, and the gallery view may be handled as described with respect to FIG. 4. Accordingly, the environments 300, 400, and 500 are intended to be illustrative and not limiting.

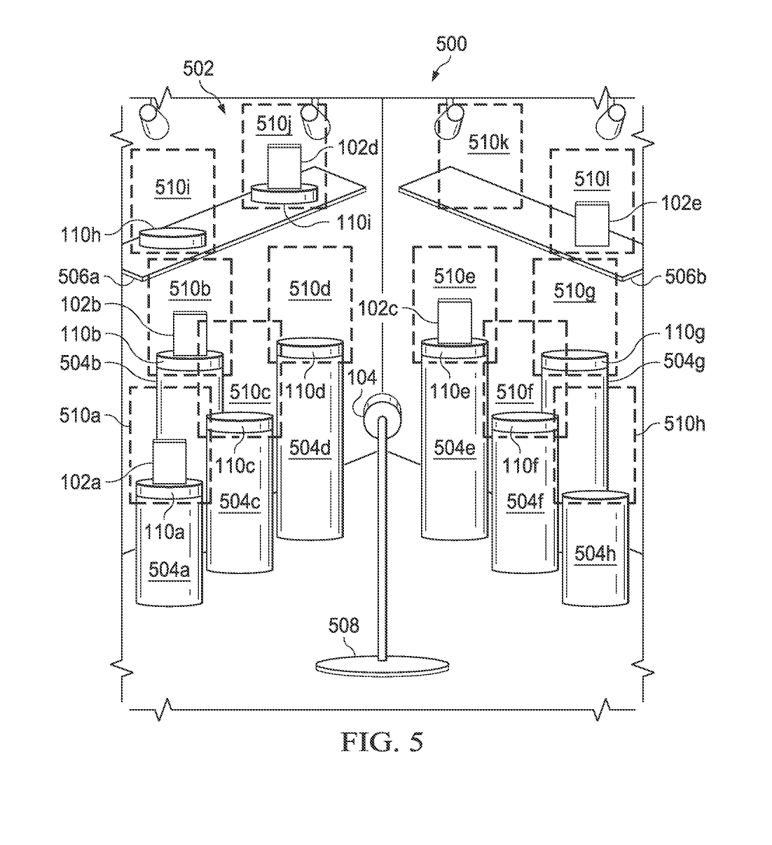

Referring to FIG. 6A, a method 600 illustrates one embodiment of step 206 of FIG. 2 in greater detail. The method 600 may be used in an environment where a camera 104 captures an image of a single object 102, such as the environments 300 of FIGS. 3 and 500 of FIG. 5. In step 602, an image of the object 102 is captured. As described previously, this may be accomplished using a dedicated camera 104 directed to the object 102 or may use a camera 104 that is controllable to take pictures of multiple objects by rotating through the objects one at a time and taking a picture of each object.

In step 604, the image may be cropped if needed. For example, the image of the object 102 may capture information that is not needed and that information may be cropped out in step 602. This may be particularly useful in environments where the camera 104 is not properly zoomed in or is unable to zoom as desired. One such instance may occur when a smaller object replaces a larger object and the camera settings remain unchanged. The cropping ensures that the focus of the image is on the object 102. The cropping may be accomplished using configurable settings within the system 100, thereby enabling the system 100 to compensate if needed.

In step 606, one or more clickable areas may be assigned to the product image. The clickable area may be the entire image or may be a portion of the image. For example, one clickable area may be the flower arrangement, while another clickable area may be the vase. In step 608, the clickable area may be linked to the product description on the server 106. For example, the uploaded image may be processed and linked to a product description within the e-commerce system 122. This allows the server 106 to identify the correct product description when the link is clicked so that a user can see the price and other product information. In step 610, the product image may be made available for viewing.

Referring to FIG. 6B, a method 620 illustrates another embodiment of step 206 of FIG. 2 in greater detail. The method 620 may be used in an environment where a camera 104 captures an image of multiple objects 102, such as the environment 400 of FIG. 4. In step 622, an image of multiple objects 102 is captured. As described previously, this may be accomplished using a camera 104 that is positioned to capture a relatively large field of view that contains multiple objects. In step 614, the image may be cropped if needed and/or areas may be defined on the image that enable the image to be zoomed in on when that area is clicked. If the gallery image is cropped into separate images, the remaining steps may be similar to steps 606-610 of FIG. 6A.

In step 626, one or more clickable areas may be assigned to the gallery image. For example, each object on display may be assigned a clickable area that links to a more detailed view of that object when the area is selected. In step 628, the clickable area may be linked to the product description on the server 106. For example, the uploaded image may be processed and linked to a product description within the e-commerce system 122. This allows the server 106 to identify the correct product description when the link is clicked so that a user can see the price and other product information. In step 630, the gallery image and/or the separate images of the objects illustrated in the gallery image may be made available for viewing.

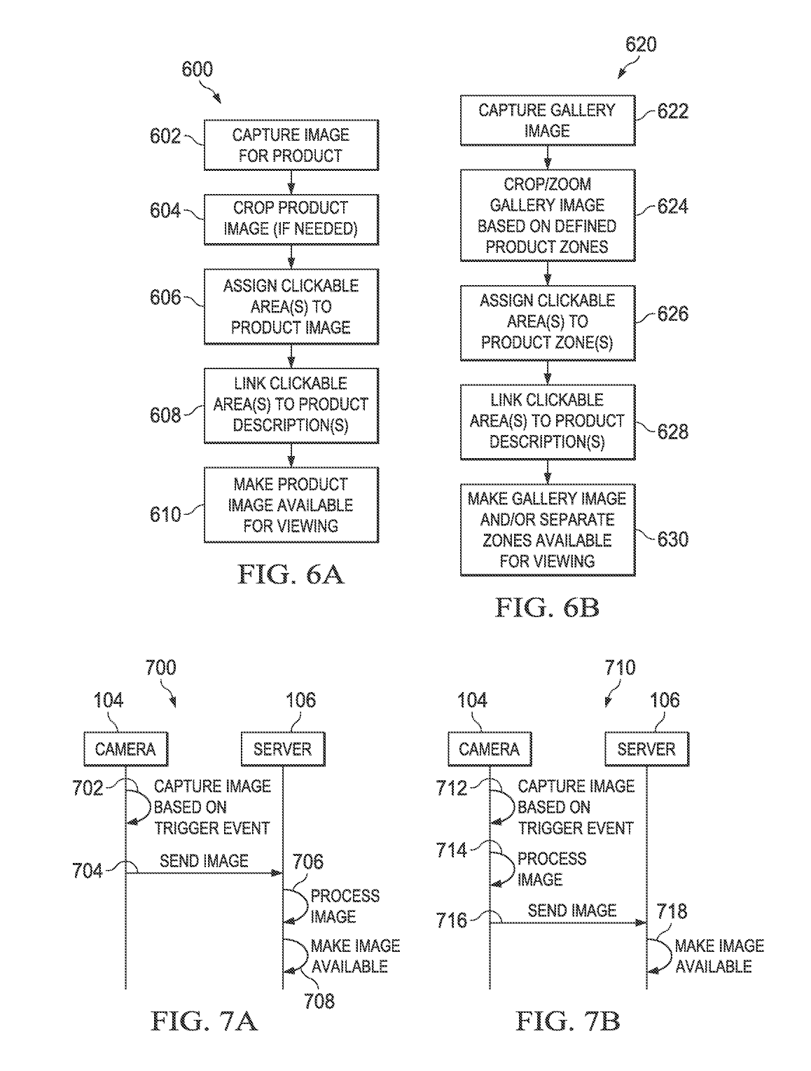

Referring to FIGS. 7A and 7B, embodiments of sequence diagrams 700 and 710, respectively, illustrate that image processing may occur on the camera (or computer coupled to the camera, although not shown) as shown in FIG. 7A or on the server 106 as shown in FIG. 7B. In other embodiments, image processing may be performed on both sides, with some processing occurring before the image is uploaded to the server 106 and some processing occurring after the image is uploaded to the server 106.

Referring specifically to FIG. 7A, in step 702, the camera 104 captures an image based on a trigger event as previously described. In step 704, the image is sent to the server 106 (e.g., to the image controller 115), which processes the image in step 706. The processing may include cropping, color/contrast/brightness correction, and any other image processing for which the server 106 is configured. In step 708, the server 106 makes the image available.

Referring specifically to FIG. 7B, in step 712, the camera 104 captures an image based on a trigger event as previously described. In step 714, the image is processed. The processing may include cropping, color/contrast/brightness correction, and any other image processing for which the camera 104 and/or a coupled computer are configured. In step 716, the image is sent to the server 106 (e.g., to the image controller 115), which makes the image available in step 718.

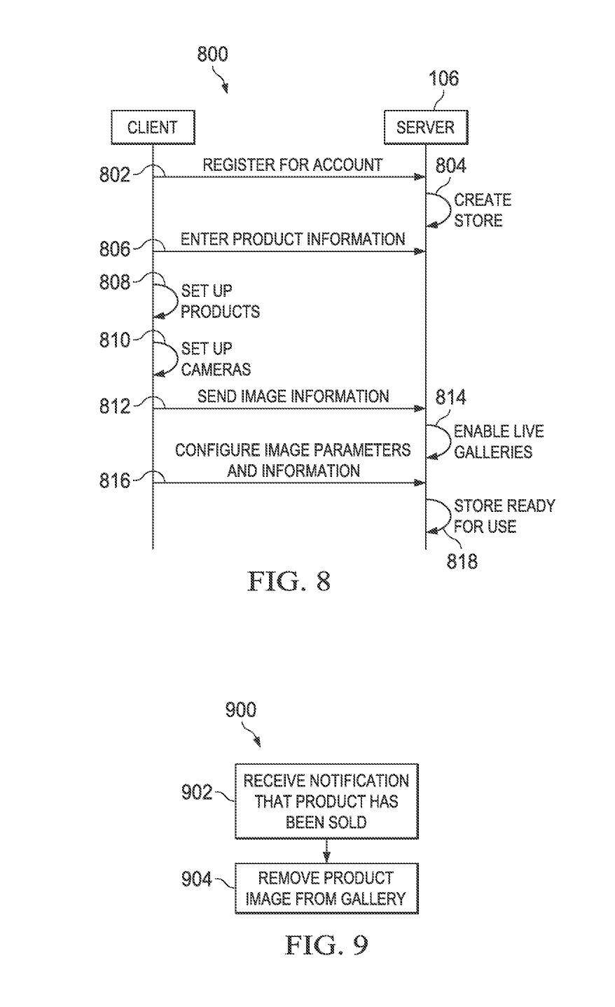

Referring to FIG. 8, one embodiment of a sequence diagram 800 illustrates a possible information flow that may be used to provide images for viewing within the system 100 of FIG. 1A. In the present example, the server 106 provides galleries as illustrated in FIG. 1B. An account is required and the server 106 is then used to provide services to that account so that images can be captured and uploaded as previously described.

Accordingly, in step 802, a client signs up for an account. For purposes of illustration, the account is established for the store 123a (FIG. 1B) and the client provides the server 106 with store information and details specific to their store. In step 804, the server 106 creates the store 123a and links the store information to the store within the e-commerce system 122. In step 806, the client may enter catalog products into the store 123a to prepare for the products that will be available. In some embodiments, the cameras may be shipped to the client during this part of the process.

In step 808, the client sets up the objects in the physical display environment. The set up may use a best practices guide that aids the client in arranging the objects for optimal photo quality while still allowing movement within the environment. In step 810, the client sets up one or more cameras based on the environment in which the images are to be captured, such as a cooler illustrated in FIGS. 3-5.

Once the cameras are set up and the server 106 receives image information and/or another type of notification as represented by step 812, the server 106 enables the live gallery or galleries in step 814. In this example, the galleries 124a-124c are enabled. In step 816, the client may view the galleries and define image parameters (e.g., crop and fully define an overview gallery for optimal viewing if desired). The client may also configure parameters such as how many products are shown in the gallery view (e.g., a range of images such one to twelve images per gallery). As illustrated by step 818, the store 123a is then ready for use.

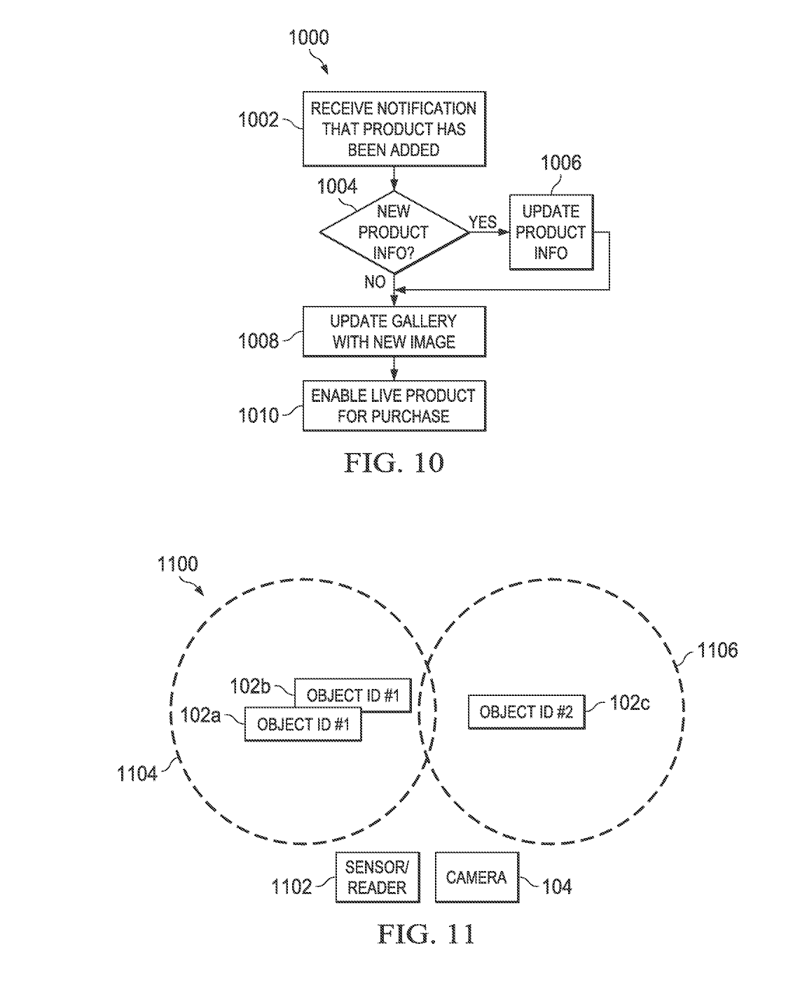

Referring to FIG. 9, a method 900 illustrates one embodiment of a process by which the system 100 of FIG. 1A may handle the removal of an image after the object represented by the image is sold or otherwise removed. In the present example, the object 102 is represented by image 126a in gallery 124a of store 123a (FIG. 1B).

In step 902, a notification is received that the object 102 has been sold. The notification may occur when the client marks the object 102 as sold in the virtual inventory controller 116 or the object may be automatically marked as sold when it is removed from a physical inventory controller 110. If the object 102 is sold online (e.g., via the store 123a), the inventory may be automatically marked as sold and the product will not be available for purchase on the store 123a. In step 904, the server 106 disables the ability to purchase the product and removes the image 126a from the gallery 124a. Even though similar objects may be available, the product is disabled because it was unique and is no longer available.

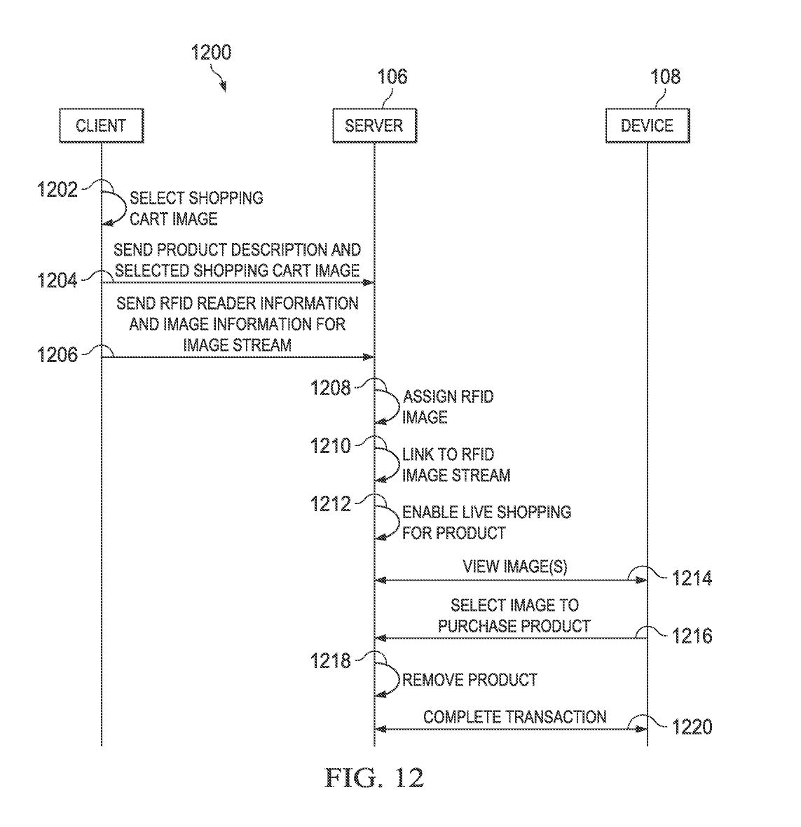

Referring to FIG. 10, a method 1000 illustrates one embodiment of a process by which the system 100 of FIG. 1A may handle adding an image for a new product. In the present example, the object 102 is represented by image 126a in gallery 124a of store 123a (FIG. 1B).

In step 1002, a notification is received that a new object 102 has been added to the store 123a. The notification may occur when the client marks the object 102 as new in the virtual inventory controller 116 or using the physical inventory controller 110. In step 1004, a determination is made as to whether new product information has been added. For example, the client may have chosen to replace a previous object with an object that requires a new price and/or description. However, if the product information is the same (e.g., a flower arrangement has been replaced with a similar flower arrangement), the information may not need to be updated.

Accordingly, if the determination of step 1006 indicates that the product information is to be updated, the method 1000 moves to step 1006 and updates the information associated with the new object. As pressing the new button may indicate that the product is ready to go live in some embodiments, the information may need to be updated prior to sending the notification of step 1002. In other embodiments where an additional step is required to enable the live purchase ability, the information may be updated later but prior to setting the product as live. After updating the information in step 1006 or if the determination of step 1004 indicates that no update is needed, the method 1000 moves to step 1008. In step 1008, the gallery 124a is updated with the new image 126a. In step 1010, the product is enabled as live and is ready to be purchased.

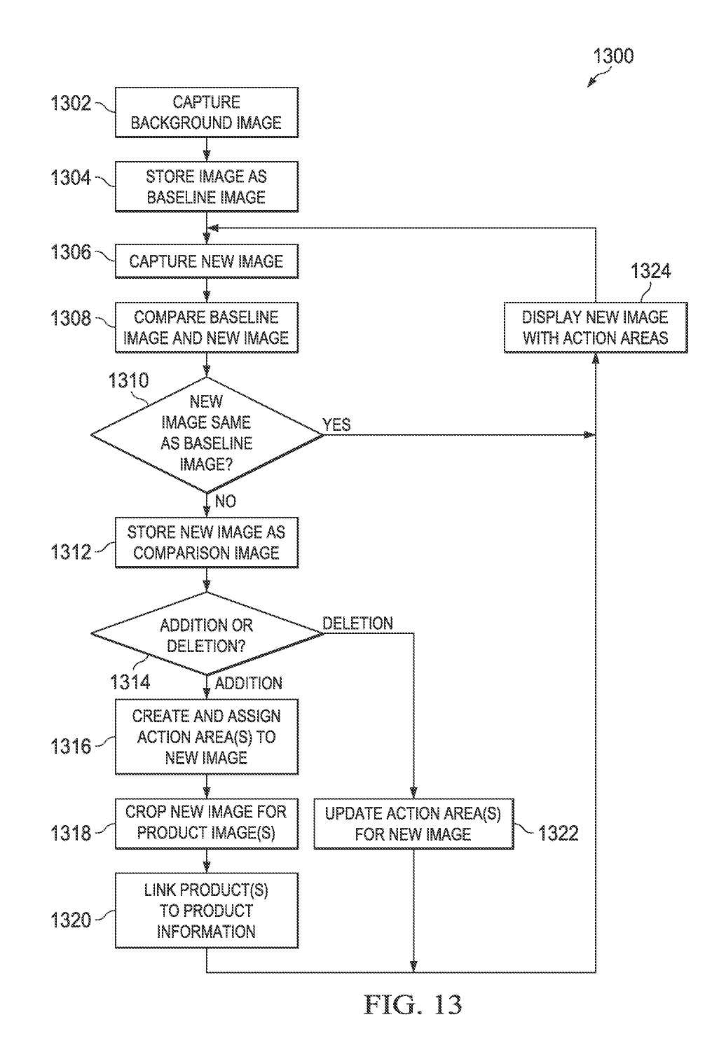

Referring to FIG. 11, in another embodiment, an environment 1100 is illustrated with the camera(s) 104 of FIG. 1A and one or more sensors/readers 1102. The environment 1100 may contain any or all of the system 100 and non-system components illustrated in FIG. 1A, but is simplified for purposes of clarity in the present example. The reader 1102 may be any type of reader, such as an RFID reader. The reader 1102 may be incorporated into the camera 104 or may be separate. Multiple readers 1102 may be used in some environments. In the present example, the camera 104 may be a controllable camera such as a motorized IP or web camera. The control may be provided by hardware (e.g., the orientation of the camera may be physically adjusted and/or the process by which the camera zooms in on a particular object may be performed by a physical lens) and/or by software (e.g., the process by which the camera zooms in on a particular object may be performed by software).

Two objects 102a and 102b are identical (e.g., not unique). For example, the objects 102a and 102b may be boxes of cereal, bulk clothing, or other items that are essentially identical and not unique in the sense that they need separate identifiers to differentiate them. However, the object 102c is unique (e.g., an original work of art, custom clothing, or a flower arrangement) and has a unique identifier that is not assigned to any other product.

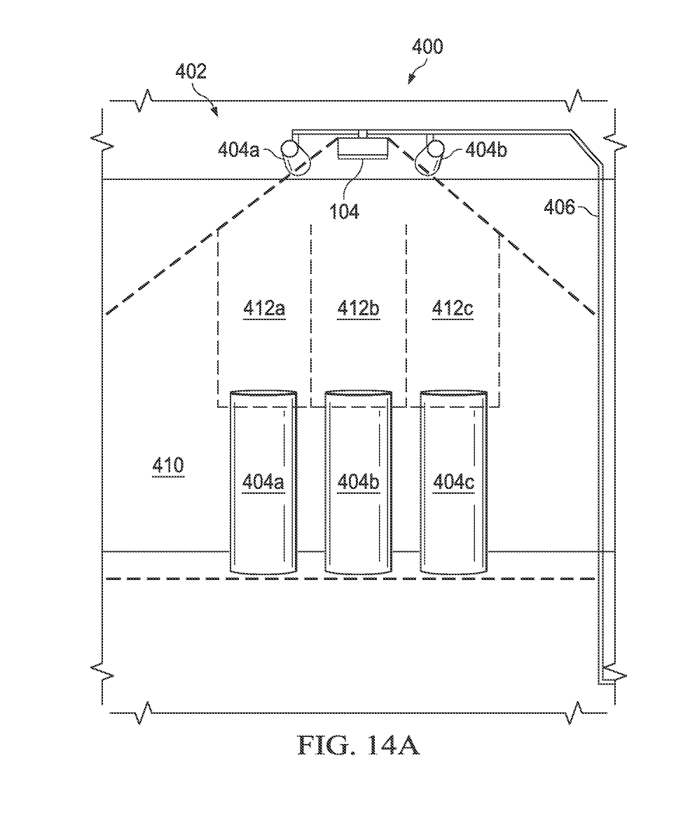

With additional reference to FIG. 12, one embodiment of a sequence diagram 1200 illustrates a possible information flow that may be used within the environment 1100 of FIG. 11. For purposes of example, RFID identifiers are used and the reader 1102 is an RFID reader, but it is understood that many different types of identifiers and identification mechanisms may be used. The camera 104 is a controllable camera that may be controlled by a user and directed to the various objects 102a-102c, as indicated by areas 1104 and 1106.

In step 1202, the client may select an image (e.g., a shopping cart image) for use with a particular product in the e-commerce system 122. The selection may include capturing an image or, in some embodiments, may use a stock image for a particular object. This image need not be a live image. In step 1204, a product description and the shopping cart image are sent to the server 106. An RFID identifier for the product may also be assigned to the product and sent to the server 106 in some embodiments. For example, the client may tag a product with an RFID identifier or scan an existing RFID identifier that is already on the product. If the product is non-unique (e.g., objects 102a and 102b), the same RFID identifier may be used for both objects. If the object is unique (e.g., the object 102c), an individually unique RFID identifier is assigned. In step 1206, images may be captured and sent to the server 106 as previously described to provide an updating image stream of the object.

In step 1208, the RFID identifier is assigned to the product corresponding to the image. In embodiments where the server 106 assigns the RFID identifier to the product rather than the client, a step may be included prior to step 1208 for this purpose. In step 1210, the RFID identifier is linked to the live or semi-live image. The product may then be enabled on the shopping cart as represented in step 1212.

In operation, the camera 104, which may be moving or stationary, broadcasts the live or semi-live image via the server 106. Accordingly, step 1206 may be repeated (as least as far as the image information is concerned) until the product is purchased or removed. The server 106 uses software to coordinate information received from the RFID reader 1102 with the live/semi-live image to identify that product in the image and in a database that may be provided by the e-commerce system 122 or may be separate.

As represented by step 1214, a consumer or other viewer may use the device 108 to view various images of products by, for example, browsing through the galleries of FIG. 1B. As the consumer is looking at the image representing the product, they may select the product for purchase by clicking on the image as represented in step 1216. Because the image is tied to the RFID number of the product shown in the image, the server 106 associates the mouse click with the product and may then remove that particular product as purchased in step 1218. The transaction may then be completed in step 1220.

While the preceding embodiments are largely described with respect to static objects such as flower arrangements, it is understood that the present disclosure may be applied to non-static objects. For example, the environment 1100 may be a pet store or animal shelter where each animal is unique but cannot realistically be prevented from moving whenever it desires. Accordingly, while the range of movement may be limited, an object 102 may move at random times and the movement may continue for a random period of time. Therefore, some functions that may be used with a static object may be modified or omitted in the environment 1100. For example, the previously described functionality of waiting to capture an image until movement has stopped may be used in the environment 1100 or may be omitted as such functionality may increase the time between updates so much that it negatively impacts the purpose of the system 100.

Because the objects in the environment 1100 are not static, the camera 104 may need to adjust to changing locations of the objects. For example, if a puppy is moving around an enclosed area, the camera 104 may need to be able to locate and focus on that particular puppy. This may be complicated if there are multiple puppies in the enclosed area, as the camera 104 must identify which of the puppies is the correct one in order to provide the correct images to the server 106.

Accordingly, an arrangement of readers 1102 and one or more cameras 104 may be used to aid the system 100 in identifying a particular object identified with a particular image being shown. For example, if the camera 104 is showing eight puppies, the system 100 may identify the RFID identifiers that are located on the collars of the puppies. If the camera 104 then zooms in on a particular puppy, the only RFID identifier that is tied to that particular image is that of the puppy in the image. The other seven RFID identifiers are no longer in the image and so will not be presented as selection options by the server 106.

It is understood that the particular configuration of the system 100 may vary based on the amount of resolution needed to correctly identify a particular object. For example, multiple readers 1102 may be employed in a manner that provides additional coverage.

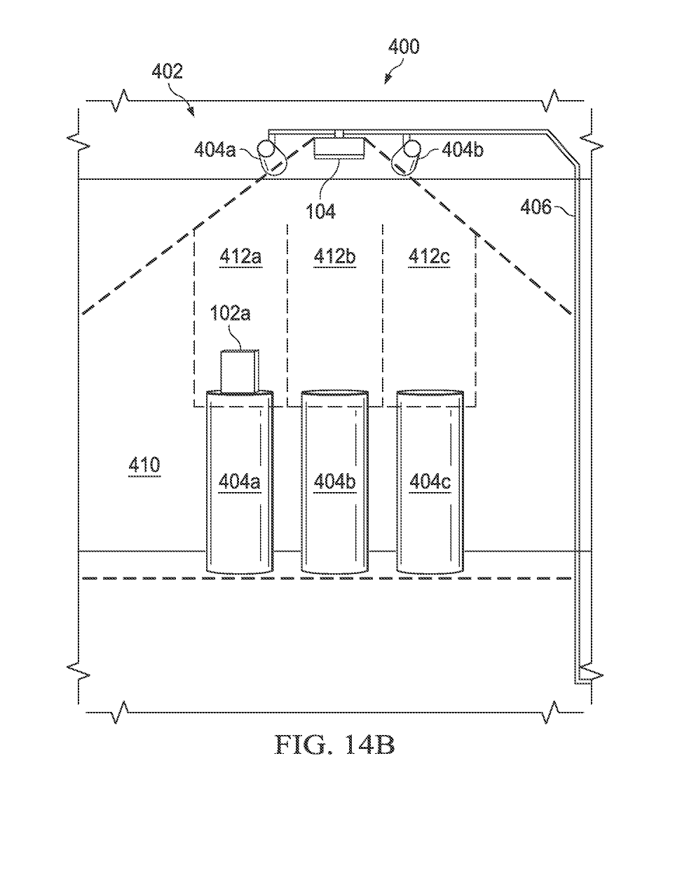

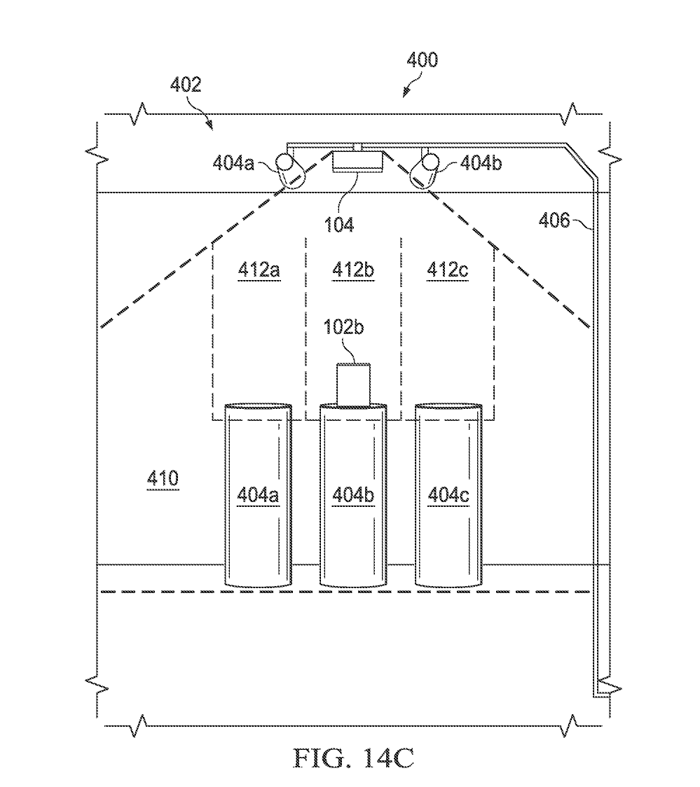

Referring to FIG. 13, in another embodiment, a method 1300 illustrates a process by which the system 100 of FIG. 1A may operate to automatically provide an image of an environment 1400 of FIGS. 14A-14C. In the present example, a background image of the environment 1400 is captured when no objects are present (FIG. 14A) and a later image can then be compared to the background image to determine whether an object has been placed into the environment (FIG. 14B). The later image and/or the background image may then be used for comparison with later images to determine if objects have been added and/or removed. The environment 1400 is similar to the environment 400 of FIG. 4 except that the physical inventory controllers 110a-110c are not present. In the present example, the method 1300 may be executed by the image controller 115 of FIG. 1A.

In step 1302 and with reference to FIG. 14A, a background image is captured of the image capture area 410. As no objects are present on the stands 404a-404c, the background image will simply be of the environment 1400. This background image is stored in step 1304 as a baseline image. It is understood that changes in the environment 1400 may require another background image to be captured, but otherwise the background image may be used repeatedly. For example, if one of the stands 404a-404c is removed or another stand or a shelf is added, an updated background image may be captured.

In step 1306 and with reference to FIG. 14B, a new image is captured. The capture may occur based on a trigger condition, such as the expiration of a timer or after detected movement has stopped.

In step 1308, the new image is automatically compared to the baseline image. In step 1310, a determination is made as to whether the new image is the same as the baseline image. It is understood that a threshold may be used in the determination of step 1310, and the baseline image and the new image may be viewed as the same as long as any changes that may exist between the baseline image and the new image do not surpass the threshold. Some changes may exist even if no objects have been added to the environment 1400 (e.g., due to lighting differences) and the threshold may be used to ensure that the change is consistent with an object being added to or removed from the image capture area 410.

There are many different ways to set a threshold and/or to determine if a change has occurred that passes the threshold. For purposes of example, a difference value may be calculated and the value may then be compared to the threshold to determine if the change is above the threshold. Such a difference value may be based on the properties of multiple pixels in the baseline and new images. For example, if the first area 412a is a solid blue color in the baseline image and contains multiple colors in the new image (as a flower arrangement likely would), then the difference may cross the threshold. However, if the first area 412a is simply a slightly different shade of blue due to lighting differences, then the difference may not cross the threshold. It is understood that a single threshold may be set for the entire image capture area or multiple thresholds may be set (e.g., a separate threshold for each area 412a-412c).

If the determination of step 1310 indicates that the new image has changed relative to the baseline image (e.g., the difference exceeds the threshold), the method 1300 moves to step 1312. In the present example, the object 102a has been added to the environment 1400 as shown in FIG. 14B, and so a change is detected and the method 1300 moves to step 1312. In step 1312, the new image is stored as a comparison image, which may be the baseline image or may be a different image. In some embodiments, the new image may replace the previous baseline image and serve as the sole basis for the determination of step 1310. In other embodiments, the new image may be used with the previously stored baseline image (e.g., the background image) as the basis for the determination of step 1310.

In step 1314, a determination is made as to whether the change is an addition or a deletion. It is understood that a change may actually encompass both an addition and a deletion, such as when a product is removed and replaced with a different product. However, the two actions are described independently in the present embodiment for purposes of clarity. Accordingly, a deletion occurs in the present example when an item is removed entirely and not replaced prior to the next image being captured.

If the determination of step 1314 indicates that the change is an addition, the method 1300 moves to step 1316. In step 1316, the method 1300 automatically creates an action area (e.g., a “clickable” or otherwise selectable area) based on the location of the identified change and assigns the created action area to the new image (e.g., links the action area to the image and defines parameters such as the action area's location on the image). For example, the current change has occurred in the first area 412a, and the system automatically creates an action area of a defined size and/or shape such as the area 412a, or creates the action area based on information from the comparison. For example, the action area may encompass only changes and so the action area may vary in size and/or shape depending on the size and/or shape of the object 102a that has been placed on the stand 404a. The action area may be stored for use with later image updates until the object is removed.

In step 1318, the method 1300 may automatically create a cropped image based on the location of the identified change. This cropped image may then be used on a page specifically tailored for that product. For example, the current change has occurred in the first area 412a, and the system may automatically crop that area (e.g., a predefined size and/or shape) such as the area 412a or may perform the cropping based on information from the comparison. For example, the cropping may encompass only changes and so the cropped area may vary in size and/or shape depending on the size and/or shape of the object 102a that has been placed on the stand 404a.

In step 1320, product information (e.g., a price and description) is linked to the action area and/or the cropped image. For example, an administrator of the system may link the information. This information remains linked to the object as long as the object is being displayed. In some embodiments, the administrator may also designate the object for sale as a live product in defined categories or as a featured object, and the object will be displayed in real time or near real time by the image. In step 1324, the new image is displayed for viewing by customers with the selectable action areas as described in previous embodiments.

If the determination of step 1314 indicates that the change is a deletion, the method 1300 moves to step 1322. In step 1322, the current action areas are updated to reflect the deletion. For example, referring to FIG. 14C, the object 102a has been removed and the object 102b has been added. The addition of the object 102b is the same process as described with respect to 102a and so is not described further. However, with the removal of the object 102a from the image area 412a, the action area for 102a will be removed from the current list of action areas and the remaining areas that are still valid will be used with the new image. In step 1324, the new image is displayed for viewing by customers with the selectable action areas as described in previous embodiments. It is noted that the formerly live product may remain in the site's catalog as a non-live item that is subject to substitution.

Referring again to step 1310, if the determination indicates that the new image is the same as the baseline image, the method 1300 moves to step 1324. In step 1324, the new image is displayed. As nothing has changed, the previously defined action areas are still valid and are used with the current image.

It is understood that the process of using an action area with an image does not necessarily mark the image itself. In other words, the action areas may be created and stored separately from the image and then applied to whatever image is stored as the current display image. In such embodiments, action areas may be present for selection by a user with respect to a displayed image even if the current display image is replaced with a completely different image that is not of the environment 1400. For example, if the image is displayed on a website, scripting on the website may track the location of a user's mouse pointer and detect whether a button push has occurred. This may happen regardless of the actual image because the scripting for the action areas is still linked to the picture being displayed. Accordingly, creating and deleting action areas may not affect the image itself, but may only affect software parameters that define how a user interacts with the image.

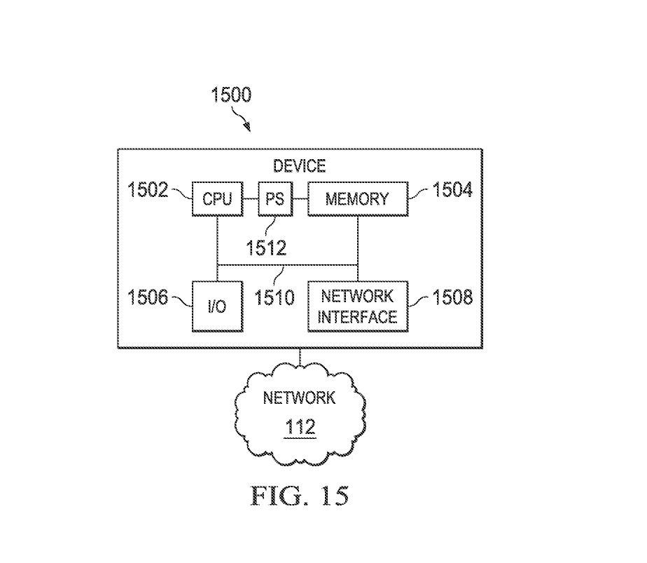

Referring to FIG. 15, one embodiment of a device 1500 is illustrated. The device 1500 is one possible example of a system component or device such as the server 106, device 108, and/or part of the camera 104 of FIG. 1A. The device 1500 may include a controller (e.g., a central processing unit (“CPU”)) 1502, a memory unit 1504, an input/output (“I/O”) device 1506, and a network interface 1508. The components 1502, 1504, 1506, and 1508 are interconnected by a transport system (e.g., a bus) 1510. A power supply (PS) 1512 may provide power to components of the device 1500, such as the CPU 1502 and memory unit 1504. It is understood that the device 1500 may be differently configured and that each of the listed components may actually represent several different components. For example, the CPU 1502 may actually represent a multi-processor or a distributed processing system; the memory unit 1504 may include different levels of cache memory, main memory, hard disks, and remote storage locations; the I/O device 1506 may include monitors, keyboards, and the like; and the network interface 1508 may include one or more network cards providing one or more wired and/or wireless connections to the network 112. Therefore, a wide range of flexibility is anticipated in the configuration of the device 1500.

The device 1500 may use any operating system (or multiple operating systems), including various versions of operating systems provided by Microsoft (such as WINDOWS), Apple (such as Mac OS X), UNIX, and LINUX, and may include operating systems specifically developed for handheld devices, personal computers, and servers depending on the use of the device 1500. The operating system, as well as other instructions (e.g., for an endpoint engine as described in a later embodiment if an endpoint), may be stored in the memory unit 1504 and executed by the processor 1502. For example, if the device 1500 is the server 106, the memory unit 1504 may include instructions for performing some or all of the message sequences and methods described herein.

The network 112 may be a single network or may represent multiple networks, including networks of different types. For example, the camera 104 may be coupled to the server 106 via a network that includes a cellular link coupled to a data packet network, or via a data packet link such as a wide local area network (WLAN) coupled to a data packet network or a Public Switched Telephone Network (PSTN). Accordingly, many different network types and configurations may be used to couple the system 100 to other components of the system and to external devices.

It will be appreciated by those skilled in the art having the benefit of this disclosure that this system and method for providing repeatedly updated visual information for an object provides advantages in presenting visual information to a viewer. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for execution by a networked computer system comprising:
receiving, by an image controller of the system, a first notification that an object is ready to be added to a memory of the system, wherein the object is linked to identifying information within the system;
receiving, by the image controller, a plurality of images of the object from a camera configured to capture images of the object, wherein the images are still images that are separated in time from one another and wherein each image is captured based on a defined trigger event that controls when the camera captures that image;
automatically handling, by the images controller, each of the plurality of images to identify whether a
making, by the image controller, each image of the plurality of images available for viewing via a network as a current image as that image is received, wherein each image updates the current image by replacing a previously received image as the current image;
receiving, by the image controller, a second notification that the image is to be removed from viewing because the object has been selected by a viewer of the image; and
marking, by the image controller, the current image to indicate that the object is no longer available.
